(19) United States
(12) Patent Application Publication
(10) Pub. No.: US 2009/0307967 A1
(43) Pub. Date: Dec. 17, 2009

(54) BIOFUEL

(75) Inventors: Martin Gardener, Kidlington (GB); Gareth Wakefield, Oxfordshire (GB); Andrew Elphick, Kidlington (GB)

Correspondence Address: WOLF GREENFIELD & SACKS, P.C., 600 ATLANTIC AVENUE, BOSTON, MA, 02210-2206, US

(73) Assignee: Oxonica Energy Ltd, Kidlington, Oxfordshire (GB)

(21) Appl. No.: 12/225,938

(22) PCT Filed: Mar. 26, 2007
(86) PCT No.: PCT/GB2007/001075

§ 371 Date: Aug. 12, 2009

(30) Foreign Application Priority Data
Apr. 6, 2006 (GB) 0606986.8

(51) Int. Cl. C10L 1/12; C01B 13/00; C01F 17/00; B01J 23/10; B01J 23/00; B32B 5/16

(52) U.S. Cl. 44/457; 423/592.1; 428/402; 502/304; 502/300

(57) ABSTRACT

Cerium or other metal oxide is used with bio-derived fuels to reduce coking and to clean up combustion chamber surfaces.

### TECHNICAL FIELD

The present invention relates to the use of an additive in biofuels to reduce or eliminate certain combustion problems, in particular problems peculiar to bio-derived fuels.

### BACKGROUND ART

Whereas conventional diesel fuel is obtained by cracking petroleum, bio-derived fuel is a fuel that is obtained more or less directly from biological materials (without the passage of geological time), generally from plant material but also from animal fats. The terms biofuel or bio-derived fuel as used in this specification has that broad definition and includes so-called biodiesel, but it should be noted that the term is elsewhere frequently used more specifically to refer to alkyl esters, such as methyl and ethyl esters of vegetable oils and animal fats (rather than the fats or oils themselves since it is usually produced by a chemical process that removes glycerin from natural oils). Biodiesel also include straight oils and fats or fatty acids. In “Biodiesel Report” from the National Biodiesel Board, Jefferson City, Mo., USA, March 1996, biodiesel was defined as the mono alkyl esters of long chain fatty acids derivable from renewable lipid feedstock, such as vegetable oils or animal fats, for use in compression ignition (diesel) engines. The present invention is preferably, although not exclusively, concerned with biodiesel according to these and other narrower definitions, such as the definitions and standards given below.

In particular, the present invention is concerned with fuels obtained by the transesterification of vegetable oils. In the UK and Europe the oil is usually obtained from rapeseed, and the product is often referred to as rapeseed methyl ester (RME); and in the USA it is usually obtained from soybean crops and is often referred to as soy methyl ester (SME or SOME). An alternative is coco methyl ester (CME). Collectively such fuels are sometimes referred to as fatty acid methyl esters (FAME). Ethyl esters may also be used.

Other sources of biodiesel include canola, palm oil methyl ester, sunflower methyl ester, tallow methyl ester and vegetable oil methyl ester. Ethanol is also regarded as a biodiesel fuel. More than one type of biodiesel may be blended together.

A further point to note is that biodiesel (according to any of the definitions above) can be blended with other fuels, in particular with petroleum diesel, and the result is often also referred to as biodiesel. Biodiesel can be blended with other cuts of the mineral oil refining process e.g. heavy fuel oil. In the present specification, a reference to fuels comprising biodiesel covers pure biodiesel and also such blends. Also used is the accepted terminology in which the prefix “BD”, standing of course for “biodiesel”, is followed by a number denoting the percentage by volume of biodiesel proper in the blend; thus BD100 is pure biodiesel, and BD10 is a fuel containing 10% of biodiesel, etc., where the remainder is usually petroleum diesel except for minor amounts of additives.

Various standards have been established for biodiesel based fuels. Reference may be made to ASTM D 6751, the Austrian standard ONORM C 1190, the German standard DIN V 51606, and the proposed European standard EN 14214.

Concern over depletion of non-renewable fuel resources has recently encouraged the use of biodiesel, and it is principally because biodiesel is a renewable fuel source that it is becoming more popular. In many respects biodiesel is similar to petroleum diesel, in some respects it is better, and in some respects it is worse. The energy content of biodiesel, or at least the more widely available RME and SOME referred to above, is similar to that of petroleum diesel although perhaps a little less, say 8 to 10% less, a typical value being about 35000 KJ per Kg; the hydrocarbon, carbon monoxide and particulate emissions of biodiesel are better than those of petroleum diesel; it has a lower sulphur content; but NOₓ emissions are generally worse.

Although biodiesel is intended to serve as an alternative to petroleum diesel, its operation in internal combustion engines cannot be regarded as exactly equivalent. That is of course clear from the above remarks concerning energy content, and different emissions characteristics. In fact, the use of biodiesel can cause many problems in internal combustion engines, in particular coking of injectors, and depositions on valves and other combustion chamber surfaces. Other problems identified include filter plugging, piston ring sticking and breaking, elastomer seal swelling and hardening or cracking, and degradation of engine lubricants. At lower ambient temperatures the generally higher viscosity of biodiesel could also cause problems.

A study of the injector and other combustion chamber deposits that result from use of biodiesel is described herein. These deposits are very different in appearance from coking that results from the use of petroleum diesel. In fact, it has been reported that “there is limited information on the effect of neat biodiesel and biodiesel blends on engine durability during various environmental conditions”, and that “more information is needed to assess the viability of using these fuels over the mileage and operating periods typical of heavy-duty engines”. See a report by the “Engine Manufacturers Association” at www.enginemanufacturers.org”.

In general, the formation of carbonaceous deposits on metallic surfaces significantly reduces the efficiency of internal combustion engines. The most significantly affected areas in the engine are, as mentioned above, the injectors and the combustion chamber. The fuel injector plays a critical role in engine function. The injector in a diesel engine sprays a metered, timed amount of fuel into the hot, compressed air in the combustion chamber. Injector deposits form over time on the small injector openings. Engine power and combustion efficiency are directly related to the quality of the injected fuel spray. Partial or complete blockage of an injector nozzle results in a poor fuel spray and hence poor combustion characteristics leading to reduced fuel economy, increased emissions and reduced power. The modification of the injector spray changes the aerosol droplet size, spray angle and spray penetration. The particulate deposits formed during poor combustion may also be deposited on the combustion chamber surface. This deposit is a result of poor incylinder combustion. Combined with changes to the fuel injection characteristics caused by injector deposits, the fuel jet may impinge on the chamber surface resulting in some fuel being absorbed into the soot layer on the chamber walls. This further reduces economy and is detrimental as regards emissions.

It is believed that at least some of these problems arise in the case of biodiesel through the polymerisation of fatty acid esters via their double bonds, leading to the formation of such engine deposits directly and also, due in part to low volatility, leading to poor atomisation and as a result to poor combustion which in turn leads to engine deposits.

### DISCLOSURE OF INVENTION

It has been found that biodiesel deposits differ considerably from petroleum deposits. Petroleum deposits are typically the result of polyaromatic ring formation leading to soot particle nucleation and to graphite structure growth incorporated into a solid organic matter phase. In contrast, biodiesel deposits typically contain no aromatic or sulphur compound but tend to contain polymeric deposits. As mentioned above, biodiesel deposits are visibly different from petroleum diesel deposits. They comprise a large amount of shiny black material into which a significant amount of unburnt biofuel can penetrate. As a result, in addition to possibly lower calorific value, higher viscosity and poorer spray characteristics, biodiesel often has a higher brake specific fuel consumption than petroleum diesel.

In spite of these peculiarities of biodiesel, it has been found that significant technical improvements in the overall use of biodiesel can be achieved by the use of a metal oxide (transition metal oxides and lanthanide metal oxides), especially a cerium oxide, optionally doped cerium oxide, or mixtures thereof particularly by incorporating it into the fuel before combustion. In particular, the present invention is able to achieve clean-up of combustion chamber surfaces, or avoidance of soot build-up in the first place, leading to reduced emissions and improved fuel economy.

Whilst cerium and other metal oxides, although not doped metal oxides, have been proposed for use in connection with biodiesel, there has been no teaching that such oxides can act at least in part through oxidation of combustion chamber deposits, returning the engine substantially to its original, clean, state. Prior art suggestions for the use of, say, cerium oxide have been in connection with carbon traps that are positioned in the exhaust system and are therefore outside the combustion chamber. The term combustion chamber includes all surfaces present in the cylinder, including the surfaces swept by the pistons as well as the combustion chamber proper above the pistons when at top dead centre, although deposits will of course tend to build up mainly in that latter region. Other surfaces present in those regions such as those of inlet and exhaust valves and those of fuel injectors, ring grooves and honing are also included. Thus, in addition to reducing future deposits, the use of the invention can result in improvements in the performance of coked engines. In spite of the usual lower calorific content and higher viscosity of biodiesel, compared to petroleum diesel, an improvement in fuel economy can be achieved by means of the present invention.

Biodiesel is considered in EP 1378560 and US 2005/0160663 which disclose the use of a cerium oxide catalyst. A cerium-platinum catalyst is disclosed in SAE Technical Paper Series 2001-01-0904. EP 1378560 is typical and discloses the use of that additive to protect emission control devices, namely catalysts and traps from degradation. It therefore relates to combustion exhaust after-treatment systems, and no suggestion is made that combustion chamber clean-up can be achieved.

At this point it may also be noted that doped cerium oxide is known for use in conjunction with petroleum diesel, see WO 03/040270. Also, reference may be made to the product “Envirox” marketed by the present applicant and disclosed in WO 02/00812. WO 2004/065529 discloses an aqueous composition for use in biodiesel.

Thus, the present invention provides a method of reducing combustion chamber biodiesel deposits in an internal combustion engine which comprises running the engine on a fuel which comprises a biodiesel and undoped or doped metal oxide such as cerium oxide.

Any one or more of a variety of metal oxides may be used. In particular transition metal oxides and lanthanide metal oxides may be used. By “lanthanide” we include any of the rare earth elements, that is any element from atomic number 58 to 71 and also including scandium, yttrium and lanthanum. Preferred transition metals include iron, manganese and copper. Currently, of those iron is most preferred. Preferred lanthanides include cerium, lanthanum, neodymium and praseodymium. Of those, cerium is most preferred. Mixtures of two or more different oxides may be used.

The invention provides most significant technical benefits in fuels that comprise at least 1%, preferably at least 5%, more preferably at least 10%, yet more preferably at least 20%, particularly at least 50%, and especially at least 75%, and optionally substantially 100% by weight of biodiesel plus the metal oxide and any other fuel additives required. It is expected that blends with increasing proportions of biodiesel will be used in the future as environmental concerns relating to non-renewable fuels increase. Currently the invention is likely to find particular benefit in BD1-BD50 blends, particularly BD5-BD20 blends, especially BD5-BD15 blends.

Preferably the concentration of the cerium or other oxide in the fuel is from 1 to 100 ppm by weight, preferably from 1 to 50 ppm, more preferably from 1 to 20 ppm, especially from 1 to 10 ppm. Often the amount will be at least 3 ppm, especially at least 5 ppm.

The metal oxides may be doped. Generally, the dopant ions will be di- or tri-valent ions of an element which is a rare earth metal, a transition metal or a metal of Group IIA, IIIB, VB, or VIB of the Periodic Table in order to provide oxygen vacancies. They should also be of a size that allows incorporation of the ion within the surface region of cerium oxide nanoparticles. Accordingly metals with a large ionic radius should not be used. For example, transition metals in the first and second row of the periodic table are generally preferred over those listed in the third row. The cerium or other oxide serves as the oxygen activation and exchange medium during a redox reaction. However, because cerium oxide and the like are ceramic materials, they have low electronic conductivity and low activity surface sites for the chemisorption of the reacting species. Transition metal additives are particularly useful to improve this situation. In addition, multivalent dopants will also have a catalytic effect of their own.

Typically doped cerium oxide will have the formula Ce₁₋ₓMₓO₂ where M is a said metal or metalloid, in particular one or more of Rh, Cu, Ag, Au, Pd, Pt, Sb, Se, Fe, Ga, Mg, Mn, Cr, Be, B, Co, V, Zr, Ti and Ca as well as Pr, Sm and Gd and x has a value up to 0.3, typically 0.01 or 0.1 to 0.2, or of the formula [(CeO₂)₁₋ₙ(REO_{y})ₙ]₁₋ₖM′ₖ where M′ is a said metal or metalloid other than a rare earth, RE is a rare earth, y is 1 or 1.5 and each of n and k, which may be the same or different, has a value op to 0.5, preferably up to 0.3, typically 0.01 or 0.1 to 0.2. Further details of suitable cerium oxide compositions can be found in PCT Application GB2002/005013 to which reference should be made.

The concentration of dopant, if present, in the cerium or other oxide is preferably from 0.1 to 20 mole %, usually at least 1 mole % and usually 8% mole percent or less.

The undoped or doped metal oxide is preferably present at a crystal size of size 1 to 300 nm, particularly 1 to 200 nm, especially 1 to 100 nm. Preferred size ranges are from 1 to 150 mm, in particular 1 to 50 nm, especially 1 to 20 nm, a particularly preferred size range being 5 to 10 μm, such as about 8 nm. It is preferred that at least 90%, more preferably at least 95% of the crystals have the sizes indicated. These sizes refer to the largest dimension of the crystal. It is preferred that the particles remain largely as single crystals, although small agglomerates of a few crystals may form.

Thus the cerium or other oxide can be dispersible or soluble in the biodiesel fuel and/or in another material compatible with the fuel. In this way a liquid additive package containing a variable number of compounds can be prepared in the factory which can be sold to end users who can simply add it to fuel storage tanks or to vehicle tanks with/or without employing special mixing or dispersing procedures. The package can be added by the end-user, by fuel refiners or distributors. Typically the concentration of cerium or other oxide in the additive package will be from 0.1 to 10%, generally 0.5 to 8%, especially from 1 to 7%, by weight. For example, one could use an additive package containing about 2% or about 5% by weight of undoped or doped oxide in a solvent, such as that known by the trade mark Exxsol D80. These packages could then be used at concentrations in the biodiesel fuel of, respectively, about 1 in 4000 and about 1 in 10000, in each case to give a concentration of the oxide in the final fuel of about 5 ppm by weight. It is preferred that the additive package be non-aqueous.

Other components of the, preferably non-aqueous, additive package will generally include some solvent or other carrier that is readily miscible with the fuel, and to that end the carrier may comprise a quantity of the fuel itself. Thus the carrier may comprise a biofuel (including biofuel blends with petroleum diesel, say from BD1 to BD100, particularly BD5-BD100, especially BD5-BD20, more especially BD5-BD15) or other material compatible with a biofuel. In order to produce the additive package and to stabilize it, stabilizers and/or dispersion aids may be included. Examples include surfactants, such as fatty acids and their derivatives, particularly those that are components of biodiesel. Examples include oleic and linoleic acid.

The particles which are subjected to the process should have as large a surface area as possible and preferably the particles have a surface area, before coating if they are to be coated, of at least 10 m²/g and preferably a surface area of at least 50 or 75 m²/g, for example 80-150 m²/g, or 100-300 m²/g.

The coating agent is suitably an organic acid, anhydride or ester or a Lewis base. The coating agent is preferably an organic carboxylic acid or an anhydride, typically one possessing at least 8 carbon atoms, for example 10 to 25 carbon atoms, especially 12 to 18 carbon atoms such as stearic acid. It will be appreciated that the carbon chain can be saturated or unsaturated, for example ethylenically unsaturated as in oleic acid. Similar comments apply to the anhydrides which can be used. They are preferably dicarboxylic acid anhydrides, especially alkenyl succinic anhydrides, particularly dodecenylsuccinic anhydride, octadecenylsuccinic anhydride and polyisobutenyl succinic anhydride. Other organic acids, anhydrides and esters which can be used in the present invention include those derived from phosphoric acid and sulphonic acid. The esters are typically aliphatic esters, for example alkyl esters where both the acid and ester parts have 4 to 18 carbon atoms.

The coating process can be carried out in an organic solvent. Preferably, the solvent is non-polar and is also preferably non-hydrophilic. It can be an aliphatic or an aromatic solvent. Typical examples include toluene, xylene, petrol, biodiesel fuel, petroleum diesel fuel as well as heavier fuel oils. Naturally, the organic solvent used should be selected so that it is compatible with the intended end use of the coated particles. The presence of water should be avoided, and the use of an anhydride as coating agent helps to eliminate any water present.

In general it has been found that the undoped or doped cerium or other oxide particles can be stabilised in the biodiesel fuel or fuel additive package by the presence of a detergent which should be selected for compatibility with the biodiesel components. Generally the mechanism of stabilisation is steric, and as a result the use of branched fatty acids with high structural disorder may be preferred.

Particular detergents which can be used in the present invention include a basic nitrogen-containing detergent. Such detergents should be ashless i.e. they contain no metals. Suitable detergents include amides, amines, Mannich bases and, preferably, succinimides. Preferably the detergent is a succinimide, which has an average of at least 3 nitrogen atoms per molecule. The succinimide is preferably aliphatic and may be saturated or unsaturated, especially ethylencally unsaturated, e.g. an alkyl or alkenyl succinimide. Typically the detergent is formed from an alkyl or alkenyl succinic acylating agent, generally having at least 35 carbon atoms in the alkyl or alkenyl group, and an alkylene polyamine mixture having an average of at least 3 nitrogen atoms per molecule. Preferably it can be formed from a polyisobutenyl succinic acylating agent derived from polyisobutene having a number average molecular weight of 500 to 10,000 and an ethylene polyamine which can include cyclic and acyclic parts, having an average composition from triethylene tetramine to pentaethylene hexamine. Thus the chain will typically have a molecular weight from 500 to 2500, especially 750 to 1500 with those having molecular weights around 900 and 1300 being particularly useful, although succinimides with an aliphatic chain with a molecular weight of about 2100 are also useful. Further details can be found in U.S. Pat. Nos. 5,932,525 and 6,048,373 and EP-A-432,941, 460309 and U.S. Pat. No. 1,237,373.

The undoped or doped cerium or other oxide can be used in conjunction with other additives suitable for biodiesel fuels, some of which are already in use in petroleum diesel fuels. Thus the additive package referred to above may additionally contain one or more of the following, or one or more of the following may be added to the biodiesel fuel before, together with or after the oxide:
non polar organic solvents such as aromatic and aliphatic hydrocarbons such as toluene, xylene and white spirit, and mixtures thereof and those sold under the Trade Marks “SHELLSOL” by the Royal Dutch/Shell Group, and “EXXSOL” by the ExxonMobil Group,
polar organic solvents, in particular alcohols generally aliphatic alcohols e.g. 2-ethylhexanol, decanol and isotridecanol,
detergents such as hydrocarbyl-substituted amines and amides, e.g. hydro carbyl-substituted succinimides, e.g. a polyisobutenyl succinimide,
dehazers, e.g. alkoxylated phenol formaldehyde polymers such as those commercially available as “NALCO” (Trade Mark) 7D07 (ex Nalco), and “TOLAD” (Trade Mark) 2683 (ex Petrolite),
anti-foaming agents e.g. polyether-modified polysiloxanes, commercially available as “TEGOPREN” (Trade Mark) 5851 (ex Th. Goldschmidt) Q 25907 (ex Dow Corning) or “RHODORSIL” (Trade Mark) (ex Rhone Poulenc)),
ignition improvers, such as aliphatic nitrates e.g. 2-ethylhexyl nitrate and cyclohexyl nitrate,
anti-rust agents e.g. those sold commercially by Rhein ChemieMannheim, Germany as “RC 4801”, or by Ethyl corporation as HiTEC (trade mark) 536, or polyhydric alcohol esters of succinic acid derivatives,
reodorants,
anti-oxidants e.g. phenolics such as 2,6-di-tert-butylphenol, or phenylenediamines, such as N,N′-di-sec-butyl-p-phenylenediamine,
metal deactivators, such as salicylic acid derivatives, e.g. N,N′-disalicylidene-1,2-propane diamine,
lubricity agents, such as polar compounds, especially fatty acids, esters and amides; typically such acids possess a C₂-C₅₀ chain and/or are aromatic and include polybasic acids such as dicarboxylic acids, for example a dimer of an unsaturated acid, such as oleic or linoleic acid, as well as hydroxy aromatic carboxylic acids, especially with an ortho OH group, for example salicylic acid, especially those which are substituted by a group possessing at least 10 carbon atoms; typical esters are derived from such acids and an alcohol which is typically a C₁ and C₅ aliphatic alcohol or a polyhydric alcohol, such as a glycol, glycerol or pentaerythritol or poly(oxyalkylene) alcohol, e.g. with 5 oxyalkylene groups, and the esters of a polybasic acid can be partial; specific esters include glycerol mono- and di-esters, such as glyceryl monooleate, sorbitan monooleate and pentaerythritol monooleate as well as salicylic esters; other lubricity agents which may be used include esters derived from a carboxyphenol and a polyol and aminoalkylmorpholines; some such agents are commercially available as EC831, P631, P633 or P639 (ex Infinium) or “HITEC” (Trade Mark) 580 (ex Ethyl Corporation), TOLAD 2670 and 9103 from Baker Petrolit and those described in WO 98/01516 and 98/16596, and
demulsifiers e.g. that which is commercially available as TOLAD 2898 from Baker Petrolite.

Preferred additives include one or more of an anti-foam agent, a demulsifier and an anti-rust agent.

Unless otherwise stated, the (active matter) concentration of each additive in the fuel is generally up to 1000 ppmw (parts per million by weight of the diesel fuel), in particular up to 800 ppmw, e.g. 1 to 1000, 1 to 800 or 1 to 20 ppmw.

The (active matter) concentration of the dehazer in the diesel fuel is preferably in the range from 1 to 20 ppmw. The (active matter) concentrations of other additives (with the exception of the detergent, ignition improver and the lubricity agent) are each preferably up to 20 ppmw. The (active matter) concentration of the detergent is typically up to 800 ppmw e.g. 10 to 500 ppmw. The (active matter) concentration of the ignition improver in the diesel fuel is preferably up to 600 ppmw e.g. 100 to 250 ppmw. If a lubricity agent is incorporated into the diesel fuel, it is conveniently used in an amount of 50 to 500 ppmw.

Some of these additives are more commonly added directly (with the cerium or other oxide) at the refinery while the others preferably form part of a diesel fuel additive (DFA) package, typically added at the point of loading with the tanker or at the pump. A typical DFA package comprises:

| detergent | 10-70% (by weight) |
|---|---|
| antirust | 0-10% |
| antifoam | 0-10% |
| dehazer | 0-10% |
| non-polar solvent | 0-50% |
| polar solvent | 0-40%. |

The biodiesel fuel itself may be an additised (additive-containing) fuel. If the biodiesel is an additised fuel, it will contain minor amounts of one or more additives, e.g. anti-static agents, pipeline drag reducers, flow improvers, e.g. ethylene/vinyl acetate copolymers or acrylate/maleic anhydride copolymers, and wax anti-settling agents, e.g. those commercially available under the Trade Marks “PARAFLOW” (e.g. “PARAFLOW” 450; ex Paramins), “OCTEL” (e.g. “OCTEL” W 500; ex Octel) and “DODIFLOW” (e.g. “DODIFLOW” V 3958; ex Hoechst).

In addition to providing a fuel as defined above, the invention also provides (CuₐMn_{b})Ce_{c}Oₓ in which a is from 0.04 to 0.06, b is from 0.02 to 0.04, c is 1−(a+b), and x is at least 2 for use as a fuel additive. Preferably a, b and c have the preferred values given above.

The invention further provides (CuₐMn_{b})Ce_{c}Oₓ as defined above for use as an additive in a fuel comprising a biodiesel.

The invention yet further provides undoped or doped cerium or other oxide for use in biodiesel soot clean-up in an internal combustion engine.

The invention still further provides undoped or doped cerium or other oxide as defined above for use in adding to fuel comprising said biodiesel prior to its combustion in a fuel burning apparatus.

Preferably the cerium or other oxide is for use in adding to said fuel prior to the introduction of the fuel to a vehicle or other apparatus comprising the internal combustion engine.

### BRIEF DESCRIPTION OF DRAWINGS

FIG. 1 shows a Kipor model KM 2200E generator incorporating a KF170E direct injection, four stroke diesel engine that was run on BD50 fuel without cerium oxide.

FIG. 2 shows the same diesel engine that was run on B50 standard fuel containing Envirox.

FIG. 3 is a TG analysis showing the difference between RF73 reference fuel CCDs and B100 biodiesel deposit CCDs.

FIG. 4 is a FTIR comparison of the CCDs formed from RF73 petroleum based fuel and B100 RME biodiesel.

FIG. 5 is a TG analysis of CCDs from B100 RME fuel with 50 ppm of the Envirox product.

FIG. 6 is a DTG analysis of CCDs from B100 RME fuel with 50 ppm of the Envirox product.

FIG. 7 is a FTIR comparison of the CCDs formed from B100 RME biodiesel fuels without the Envirox product (top spectrum) and with the Envirox product (bottom spectrum).

The Examples which follow further illustrate the present invention with reference to the figures.

### EXAMPLE 1

BD50 biodiesel was prepared by measuring 500 ml of rapeseed methyl ester (RME) into a 1000 ml HPDE measuring cylinder. 0.1 ml of 5 wt % Envirox was added. The solution was made up to 1000 ml using RF 73 reference fuel and stirred vigorously for 10 minutes to give a homogeneous mixture. This was repeated to give the required total volume of fuel.

A Kipor model KM2200E generator incorporating a KF170E direct injection, four stroke diesel engine operating at 3000 rpm was used to assess the effect of the doped cerium oxide on the performance of the BD50 fuel.

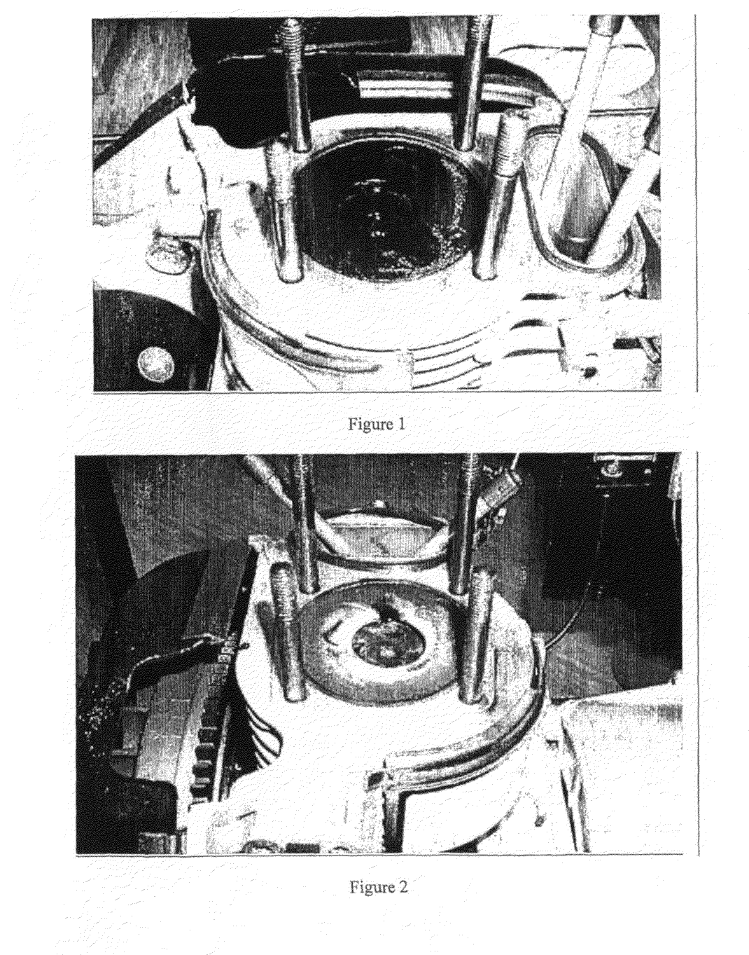

The engine was run on the BD50 fuel without cerium oxide for 3 hours at 3000 rpm. The head was removed and digital images of the combustion chamber deposits recorded. This is shown in FIG. 1.

It was found that use of the standard fuel caused notable deposition of a shiny black deposit on the combustion chamber.

The B50 standard fuel was then replaced by B50 fuel containing 5 ppm Envirox under the same operating conditions for the same period of time. Following the test the engine was disassembled and inspected. This is shown in FIG. 2.

The combustion chamber deposits were notably reduced returning the deposit morphology to its original state with some areas of the combustion chamber having little or no deposit.

### EXAMPLE 2

A Kipor KDE2200E 2.8 kW generator was disassembled and the combustion chamber, injection, head surfaces and piston crown cleaned by mild abrasion to remove carbonaceous deposits. The engine was reassembled and run at 3000 rpm at zero load for 3 hours. The engine head was removed and inspected. The combustion chamber was filled with acetone and deposits were removed using a plastic spatula. The acetone and combustion chamber deposits (CCDs) were then removed with a syringe. This process was repeated until all deposits were removed from the combustion chamber. The acetone was evaporated in a petri-dish at 60° C. and the deposit mass recorded. This procedure was performed when the engine was run on each of the following fuels: (i) petroleum based RF73 reference fuel, (ii) B100 rapeseed methyl ester biodiesel and (iii) the B100 fuel including 50 ppm of the Envirox product.

The CCDs were analysed by thermogravimetric analysis (TGA) at 10° C./min in air. FTIR were recorded as KBr disks from 400-4000 cm⁻¹.

### Results

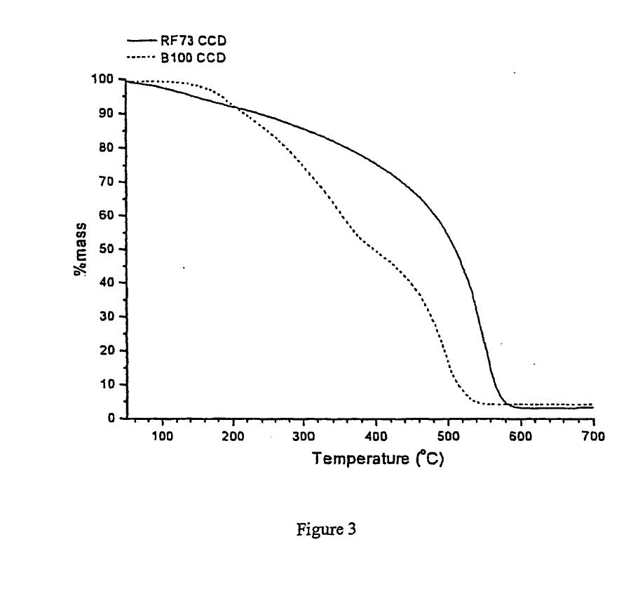

The TGA analysis (see FIG. 3) shows clear differences in the oxidative reactivity of the RF73 and B100 deposits. CCDs from RF73 fuel show a gradual mass loss from room temperature to around 450° C. This is followed by a rapid mass loss at 540° C. ending at 600° C. with a residue of 3.1 wt %. No further mass loss was observed above 700° C. The profile is most likely to result from progressive vaporisation of low molecule weight hydrocarbons in the deposit followed by oxidation of larger molecular weight carbonaceous graphitic-like deposits. The B100 RME biodiesel CCD shows a significantly different TGA profile compared to RF73 CCDs. From room temperature to 180° C. the B100 RME CCD shows no mass loss. This is followed by three significant mass losses centred at 200, 350 and 500° C. The final residual mass of the B100 RME CCD was 4.2 wt %. No further mass loss was observed above 700° C.

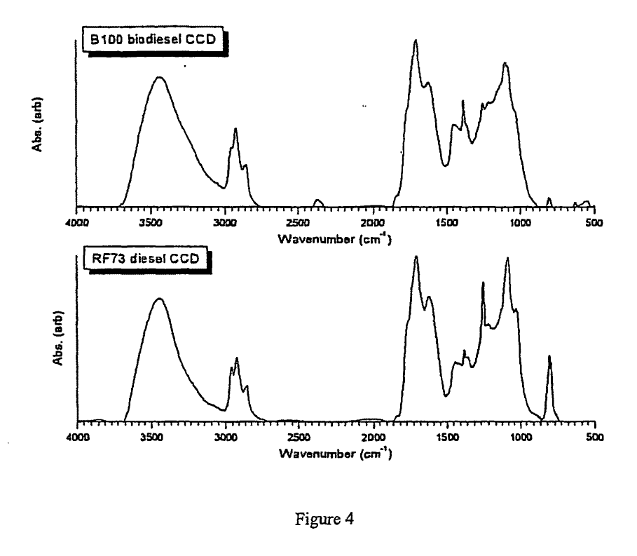

Comparison of FTIR spectra of the RF73 and B100 biodiesel CCDs (see FIG. 4) shows differences between bond structures of the deposits. Deposits from both fuel types show similar OH and C—H structure indicating the presence of unburned hydrocarbon in both deposits. From 1800-1500 cm⁻¹ both deposits also exhibit similar carbonyl structures. The 1500-1300 cm⁻¹ region shows the most significant differences between deposits. This region largely results from C—C structures in the deposit. The RF73 fuel deposit has significantly lower C—C absorption than B100 RME biodiesel. This indicates the biodiesel is formed of shorter chained hydrocarbons with a higher C—H/C—C ratio in comparison with RF73 fuel CCDs.

### Effect of Envirox

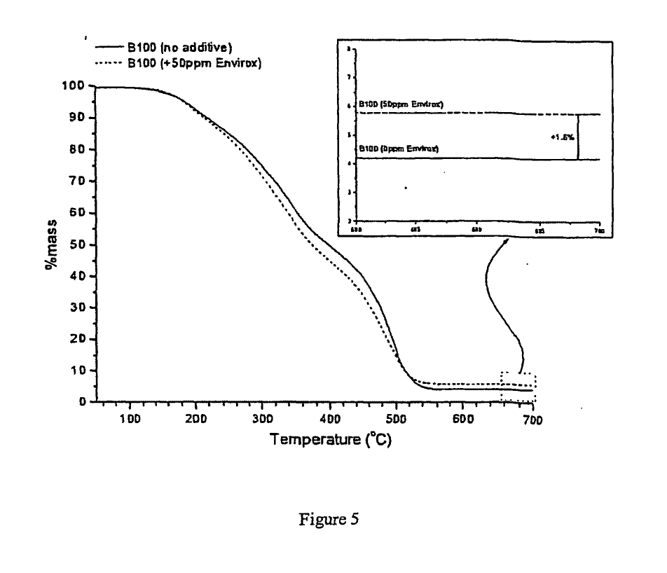

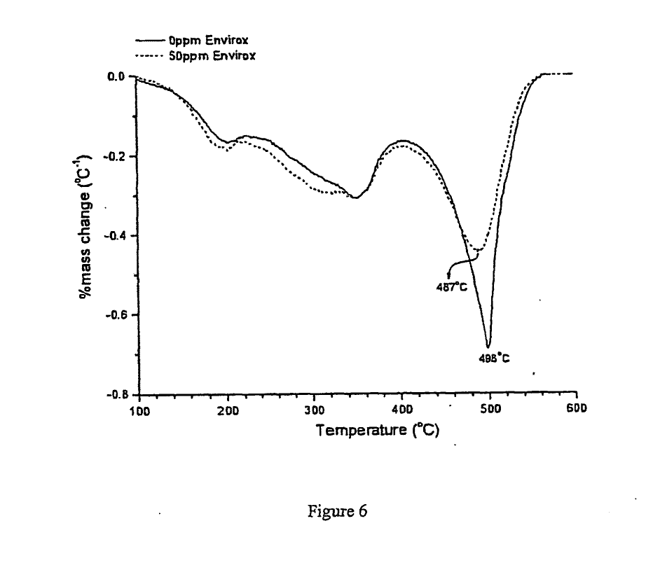

CCDS produced from B100 biodiesel fuel in the TGA (see FIG. 5) show no mass loss up to 120° C. indicating no highly volatile components. From the DTG trace three significant mass losses are observed at 200, 350 and 490° C. The DTG illustrates the effect of Envirox on oxidative reactivity of CCDs. For the 200° C. oxidation rate maximum, the rate shows a slight shift to lower temperatures and an increase in maximum rate indicating Envirox catalyses this reaction. Oxidative reactions taking place between 200 and up to 350° C. are also increased in rate. Oxidation of the material at 500° C. is shifted approximately 10° C. lower but also the fraction of the material in the CCD is reduced by the presence of Envirox indicating the ability of the ceria to reduce the deposition of such material while making its oxidation occur at lower temperatures.

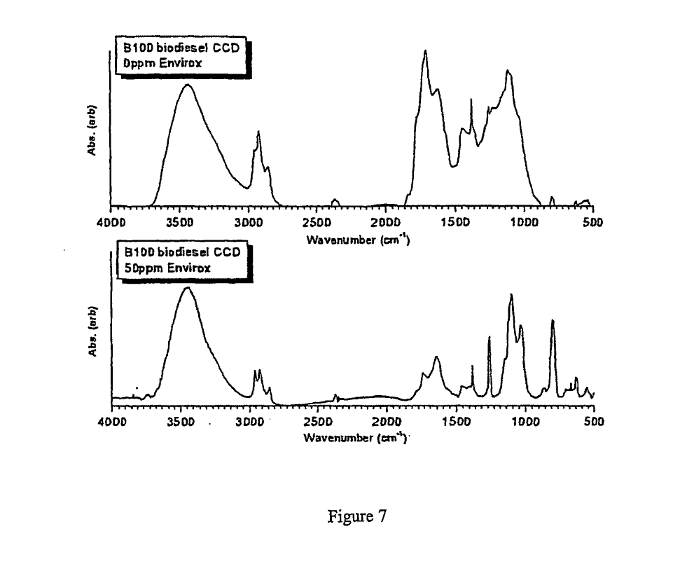

FIG. 7 shows the effect of Envirox on the FTIR spectrum of the CCD deposited from B100 RME biodiesel fuel. The FTIR spectrum shows the bond structure of the material and a relative comparison of bond types in its composition. The 3800 to 3100 cm⁻¹ shows hydroxyl bond, 3000-2700 cm⁻¹ is C—H type bonds, 2000-1500 cm⁻¹ is carbonyl C—O type bonds while 1500-1000 cm⁻¹ is largely due to the presence of C—C bonds but also contains inorganic species such as nitrate and sulphate. Below 1000 cm⁻¹ is the fingerprint region and is highly complex and compound specific.

CCDs produced from B 100 RME biodiesel show all types of these bond structures. CCDs formed with Envirox present show a very different structure. The relative amount of C—H is decreased while the C—O structure is significantly reduced. The C—C region shows loss of a large amount of structure. This data indicates that Envirox significantly disrupts the hydrocarbon structure of the CCD by breaking larger hydrocarbons. It is most likely that Envirox therefore has a significant oxidative contribution, either during combustion, after or possibility both, on the methyl ester and extends the oxidation further than in the unadditised fuel alone.

### CONCLUSIONS

Combustion chamber deposits formed from RF73 reference fuel have significant differences from B 100 RME biodiesel fuel as evidenced by their oxidative reactivity. Addition of 50 ppm Envirox to B100 RME biodiesel fuel results in a more easily oxidized CCD with the ceria acting, either during or post-combustion, to oxidise the hydrocarbon structure more completely.

1. A method of reducing combustion chamber biofuel deposits in fuel burning apparatus which comprises running the engine on a fuel which comprises a bio-derived fuel and a metal oxide.

2. A method according to claim 1, which comprises at least 5% by weight of bio-derived fuel.

3. A method according to claim 1, in which the metal oxide is present at a crystal size of 1 to 300 nm.

4. A method according to claim 3, in which the particles comprise metal oxide within a coating.

5. A method according to claim 4, in which the coating comprises a surfactant.

6. A method according to claim 5, in which the surfactant comprises dodecylsuccinic anhydride and/or stearic acid or fatty acid derivatives.

7. A method according to claim 1, in which the concentration of metal oxide in the fuel is from 1 to 100 ppm.

8. A method according to claim 1, in which the metal oxide is doped.

9. A method according to claim 8, in which the metal oxide is doped with copper and/or manganese.

10. A method according to claim 8, in which the metal oxide is doped with more than one dopant.

11. A method according to claim 8, in which the concentration of dopant in the metal oxide is from 1 to 8% mole percent.

12. A method according to claim 8 any preceding claim in which the metal oxide comprises a cerium oxide.

13. A metal oxide for use in biodiesel soot clean-up within the combustion chamber of an internal combustion engine.

14. A metal oxide as claimed in claim 13, in which the soot clean-up takes place at fuel injectors and/or on an inlet and/or exhaust valve.

15. A metal oxide according to claim 13, for use in adding to fuel comprising said biodiesel prior to its combustion in the engine.

16. A metal oxide according to claim 15, for use in adding to said fuel prior to the introduction of the fuel to a vehicle or other apparatus comprising the engine.

17. A metal oxide according to claim 14, in the form of particles of size 1 to 300 nm.

18. A metal oxide according to claim 17, in which the particles comprise metal oxide within a coating.

19. A metal oxide according to claim 14, which is a cerium oxide.

20. A metal oxide according to claim 14, which is doped.

21. Doped metal oxide according to claim 20 which is a cerium oxide.

22. A method according to claim 2, in which the metal oxide is present at a crystal size of 1 to 300 nm.

23. A method according to claim 22, in which the concentration of metal oxide in the fuel is from 1 to 100 ppm.

24. A method according to claim 22, in which the metal oxide is doped.

25. A method according to claim 24, in which the metal oxide is doped with copper and/or manganese.

26. A metal oxide according to claim 19, which is doped.
